(19) United States
(12) Patent Application Publication
(10) Pub. No.: US 2006/0107466 A1
(43) Pub. Date: May 25, 2006

(54) Composition for treating textile fiber articles comprising a dendritic polymer

(76) Inventors: Jean-Francois Sassi, Saint Roman En Juarez (FR); Ian Harrison, Poissy (FR); Franck Touraud, Vernon (FR)

Correspondence Address: Jean-Louis Seugnet;Rhodia Inc, 259 Prospect Plains Road, CN 7500, Cranbury, NJ, 08512, US

(21) Appl. No.: 10/517,270

(22) PCT Filed: Jun. 6, 2003
(86) PCT No.: PCT/FR03/01704

§ 371 Date: Jan. 11, 2006

(30) Foreign Application Priority Data
Jun. 11, 2002 (FR) 02/07139

(51) Int. Cl. C11D 3/00

(52) U.S. Cl. 8/115.51

(57) ABSTRACT

The invention relates to a composition for the treatment of articles made of textile fibres which is intended to be used for washing and/or rinsing, drying in a tumble dryer or ironing articles made of textile fibres comprising a dendritic polymer (in particular a hyperbranched polyamide). The invention also relates to the use, in a composition for the treatment of articles made of textile fibres which is intended to be used for washing and/or rinsing, drying in a tumble dryer or ironing articles made of textile fibres, of a dendritic polymer (in particular hyperbranched polyamide) as antiwrinkling agent or ease-of-ironing agent.

A subject-matter of the present invention is a composition for the treatment of articles made of textile fibres which is intended to be used for washing and/or rinsing, drying in a tumble dryer or ironing articles made of textile fibres comprising a dendritic polymer (in particular a hyperbranched polyamide). Another subject-matter of the invention is the use, in a composition for the treatment of articles made of textile fibres intended to be used for washing and/or rinsing, drying in a tumble dryer or ironing articles made of textile fibres, of a dendritic polymer (in particular hyperbranched polyamide) as antiwrinkling agent or ease-of-ironing agent.

The cleaning of the laundry in a washing machine, which comprises a drying operation, results in wrinkled laundry; wrinkling is accentuated during drying, in particular by the formation of interfibre hydrogen bonds. An ironing operation is therefore necessary to obtain a presentable appearance of the laundry.

Provision has been made to employ, in detergent compositions for washing articles made of textile fibres, hyperbranched polymers of DAB(PA)N type from DSM exhibiting a diaminobutane “core” and ω-aminopropyl branchings on the nitrogen for preventing transfer of colours (U.S. Pat. No. 5,872,093 and EP-A-875 521).

The Applicant Company has found that the use of certain water-soluble or water-dispersible dendritic polymers in compositions for washing and/or rinsing, drying in a tumble dryer or ironing the laundry makes it possible to give the laundry antiwrinkling properties or ease-of-ironing properties.

Dendritic polymers (dendrimers and hyperbranched polymers) are polymeric structures exhibiting numerous branchings.

A first subject-matter of the invention is a composition for the treatment of articles made of textile fibres which is intended to be used for washing and/or rinsing, drying in a tumble dryer or ironing articles made of textile fibres comprising at least one water-soluble or water-dispersible dendritic or hyperbranched polymer (P) capable of being obtained by:

(1) polycondensation of at least one multifunctional monomer of formula (I) comprising at least three reactive polycondensation functional groups,
A-R—(B)_{f} (I)
in which formula

f is an integer greater than or equal to 2, preferably ranging from 2 to 10, very particularly equal to 2,

the symbol A represents a reactive functional group or a group carrying a reactive functional group chosen from the amino, carboxyl, hydroxyl, oxiranyl, halo or isocyanato functional groups or their precursors,

the symbol B represents a reactive functional group or a group carrying a reactive functional group chosen from the amino, carboxyl, hydroxyl, oxiranyl, halo or isocyanato functional groups or their precursors which is an antagonist of A,

the symbol R represents a linear or branched aliphatic, cycloaliphatic or aromatic polyvalent hydrocarbon residue comprising from 1 to 50, preferably from 3 to 20, carbon atoms which is optionally interrupted by one or more oxygen, nitrogen, sulphur or phosphorus heteroatoms, the said residue optionally carrying functional groups not capable of reacting with the A and B functional groups,

2) and optionally at least partial hydrophilic functionalization of the polymer obtained in the polycondensation stage.

The symbol B represents a reactive functional group which is an antagonist of the reactive functional group A; this means that the functional group B is capable of reacting with the functional group A by condensation. Thus, the functional groups which are antagonists

of an amino functional group are in particular the carboxyl (formation of an amide), isocyanato (formation of a urea) or oxiranyl (formation of a β-hydroxylated secondary or tertiary amine) functional groups,

of a carboxyl functional group are in particular the amino (formation of an amide), hydroxyl (formation of an ester) or isocyanato (formation of an amide) functional groups,

of a hydroxyl functional group are in particular the carboxyl (formation of an ester), oxiranyl (formation of an ether) or isocyanato (formation of an amide) functional groups,

of an oxiranyl functional group are in particular the hydroxyl (formation of an ether), carboxyl (formation of an ester) or amino (formation of a β-hydroxylated secondary or tertiary amine) functional groups,

of an isocyanato functional group are in particular the amino, hydroxyl or carboxyl functional groups,

of a halo functional group are in particular the hydroxyl functional groups.

Mention may in particular be made, among amino functional group precursors, of amine salts, such as hydrochlorides.

Mention may in particular be made, among carboxyl functional group precursors, of esters, preferably C₁-C₄, very particularly C₁-C₂, esters, acid halides, anhydrides or amides.

Mention may in particular be made, among hydroxyl functional group precursors, of epoxy compounds.

According to an alternative embodiment, the said polycondensation operation is carried out in addition in the presence
of at least one bifunctional monomer in the linear form of formula (II) in the corresponding cyclic form comprising two reactive polycondensation/polymerization functional groups
   A′-R′—B′ (II)
   in which formula
   the symbol A′, which is identical to or different from A, represents a reactive functional group chosen from the amino, carboxyl, hydroxyl, oxiranyl, halo or isocyanato functional groups or their precursors which is an antagonist of B and B′,
   the symbol B′, which is identical to or different from B, represents a reactive functional group chosen from the amino, carboxyl, hydroxyl, oxiranyl, halo or isocyanato functional groups or their precursors which is an antagonist of A and A′,
   the symbol R′, which is identical to or different from R, represents a linear or branched aliphatic, cycloaliphatic or aromatic polyvalent hydrocarbon residue comprising from 1 to 50, preferably from 3 to 20, carbon atoms which is optionally interrupted by one or more oxygen, nitrogen, sulphur or phosphorus heteroatoms, the said residue optionally carrying functional groups not capable of reacting with the A, A′, B and B′ functional groups,
the reactive functional group A′ being capable of reacting with the B functional group and/or the B′ functional group by condensation;
the reactive functional group B′ being capable of reacting with the A functional group and/or the A′ functional group by condensation;
and/or of at least one “core” monomer of formula (III) comprising at least one functional group capable of reacting by condensation with the monomer of formula (I) and/or the monomer of formula (II)
   R¹—(B″)ₙ (III)
   in which formula
   n is an integer greater than or equal to 1, preferably ranging from 1 to 100, very particularly from 1 to 20,
   the symbol B″ represents a reactive functional group, identical to or different from B or B′, chosen from the amino, carboxyl, hydroxyl, oxiranyl, halo or isocyanato functional groups or their precursors which is an antagonist of A and A′,
   the symbol R¹ represents a linear or branched aliphatic, cycloaliphatic or aromatic polyvalent hydrocarbon residue comprising from 1 to 50, preferably from 3 to 20, carbon atoms which is optionally interrupted by one or more oxygen, nitrogen, sulphur or phosphorus heteroatoms or an organosiloxane or polyorganosiloxane residue, the said R¹ residue optionally carrying functional groups not capable of reacting with the A, A′, B, B′ and B″ functional groups,
the reactive functional group B″ being capable of reacting with the A functional group and/or the A′ functional group by condensation;
and/or of at least one “chain-limiting” monofunctional monomer of formula (IV)
   A″-R² (IV)
   in which formula
   the symbol A″ represents a reactive functional group, identical to or different from A or A′, chosen from the amino, carboxyl, hydroxyl, oxiranyl, halo or isocyanato functional groups or their precursors which is an antagonist of B, B′ and B″,
   the symbol R² represents a linear or branched aliphatic, cycloaliphatic or aromatic polyvalent hydrocarbon residue comprising from 1 to 50, preferably from 3 to 20, carbon atoms which is optionally interrupted by one or more oxygen, nitrogen, sulphur or phosphorus heteroatoms or an organosiloxane or polyorganosiloxane residue, the said R² residue optionally carrying functional groups not capable of reacting with the A, A′, A″, B, B′ and B″ functional groups,
the reactive functional group A″ being capable of reacting with the B functional group and/or the B′ functional group and/or the B″ functional group by condensation;
at least one of the reactive functional groups of at least one of the monomers of formula (II), (III) or (IV) being capable of reacting with an antagonistic functional group of the multifunctional monomer of formula (I).

Preferably, the A, A′, A″ and B, B′, B″ functional groups are chosen from reactive functional groups or groups carrying reactive functional groups chosen from the amino, carboxyl, hydroxyl or oxiranyl functional groups or their precursors. More preferably still, the said functional groups are chosen from reactive amino and carboxyl functional groups or groups carrying reactive amino and carboxyl functional groups or their precursors.

For good implementation of the invention,
the molar ratio of the monomer of formula (I) to the monomer of formula (II) is greater than 0.05 and preferably ranges from 0.125 to 2;
the molar ratio of the monomer of formula (III) to the monomer of formula (I) is less than or equal to 1, preferably less than or equal to 1/2 and more preferably still ranges from 0 to 1/3; the said ratio ranges very particularly from 0 to 1/5;
the molar ratio of the monomer of formula (IV) to the monomer of formula (I) is less than or equal to 10, preferably less than or equal to 5; the said ratio ranges very particularly from 0 to 2, when f is equal to 2.

The fundamental entity taken into consideration in defining the various molar ratios is the molecule.

It is obvious that the expression “condensation reaction” also includes the notion of addition reaction when one or more antagonistic functional groups of at least one of the monomers employed is included in a ring (lactams, lactones or epoxides, for example).

Mention may be made, as examples of monomer (I), of:
5-aminoisophthalic acid,
6-aminoundecanedioic acid,
3-aminopimelic acid,
aspartic acid,
3,5-diaminobenzoic acid,
3,4-diaminobenzoic acid,
lysine,
α,α-bis(hydroxymethyl)propionic acid,
α,α-bis(hydroxymethyl)butyric acid,
α,α,α-tris(hydroxymethyl)acetic acid
α,α-bis(hydroxymethyl)valeric acid
α,α-bis(hydroxy)propionic acid
3,5-dihydroxybenzoic acid
or their mixtures.

Mention may be made, as examples of bifunctional monomer of formula (II), of:
ε-caprolactam,
aminocaproic acid,
para- or meta-aminobenzoic acid,
11-aminoundecanoic acid,
lauryllactam,
12-aminododecanoic acid,
hydroxyacetic acid (glycolic acid),
hydroxyvaleric acid,
hydroxypropionic acid,
hydroxypivalic acid,
glycolide,
δ-valerolactone,
β-propiolactone,
ε-caprolactone,
lactide
lactic acid
or their mixtures.

More preferably, the bifunctional monomers of formula (II) are the monomers used for the manufacture of linear thermoplastic polyamides. Thus, mention may be made of co-aminoalkanoic compounds comprising a hydrocarbon chain having from 4 to 12 carbons, or the lactams derived from these amino acids, such as ε-caprolactam. The bifunctional monomer preferred for the implementation of the invention is ε-caprolactam.

According to an advantageous form of the invention, at least a portion of the bifunctional monomers (II) are in the prepolymer form.

Mention may be made, as examples of the monomers (III), of:
aromatic or aliphatic monoamines, such as dodecylamine, octadecylamine, benzylamine, and the like,
aromatic or aliphatic monoacids comprising from 1 to 32 carbon atoms, such as benzoic acid, acetic acid, propionic acid or saturated or unsaturated fatty acids (dodecanoic acid, oleic acid, palmitic acid, stearic acid, and the like),
monofunctional alcohols or epoxides, such as ethylene oxide, epichlorohydrin, and the like,
isocyanates, such as phenyl isocyanate, and the like,
biprimary diamines, preferably linear or branched saturated aliphatic biprimary diamines having from 6 to 36 carbon atoms, such as, for example, hexamethylenediamine, trimethylhexamethylenediamine, tetramethylenediamine or m-xylenediamine,
saturated aliphatic dicarboxylic acids having from 6 to 36 carbon atoms, such as, for example, adipic acid, azelaic acid, sebacic acid, maleic acid or maleic anhydride,
difunctional alcohols or epoxides, such as ethylene glycol, diethylene glycol, pentanediol or glycidyl ethers of monofunctional alcohols comprising from 1 to 24 carbon atoms,
diisocyanates, such as toluene diisocyanates, hexamethylene diisocyanate, phenylene diisocyanate or isophorone diisocyanate,
triols or polyols or aromatic or aliphatic triamines, triacids or polyacids, such as N,N,N-tris(2-aminoethyl)amine, melamine, and the like, citric acid, 1,3,5-benzenetricarboxylic acid, and the like, 2,2,6,6-tetra(β-carboxyethyl)-cyclohexanone, trimethylolpropane, glycerol, pentaerythritol or glycidyl ethers of di-, tri- or polyfunctional alcohols,
polymeric compounds, such as the polyaminated polyoxyalkylenes sold under the Jeffamine® trade mark,
aminated polyorganosiloxanes, such as aminated polydimethylsiloxanes.

The preferred “core” monomers (III) are: hexamethylenediamine, adipic acid, Jeffamine® T403, sold by Huntsman, 1,3,5-benzenetricarboxylic acid and 2,2,6,6-tetra(β-carboxyethyl)cyclohexanone.

Mention may be made, as examples of the monomers (IV), of:
aromatic or aliphatic monoamines, such as dodecylamine, octadecylamine, benzylamine, and the like,
aromatic or aliphatic monoacids comprising from 1 to 32 carbon atoms, such as benzoic acid, acetic acid, propionic acid or saturated or unsaturated fatty acids (dodecanoic acid, oleic acid, palmitic acid, stearic acid, and the like),
monofunctional alcohols or epoxides, such as ethylene oxide, epichlorohydrin, and-the like,
isocyanates, such as phenyl isocyanate, and the like,
polymeric compounds, such as the monoaminated polyoxyalkylenes sold under the Jeffamine M® trade mark, such as Jeffamine M 1000® and Jeffamine M2070®,
monoaminated silicone chains, such as monoaminated polydimethylsiloxanes.

Mention may in particular be made, among functional groups which may be present in the monomers (I) to (IV) and which are not capable of reacting with the A, A′, A″, B, B′ and B″ functional groups, of functional groups capable of introducing hydrophilicity to or of improving the hydrophilicity of the dendritic polymers employed according to the invention, in order to improve the affinity of the dendritic polymers with textile fibres (in particular cotton fibres) or in order to improve the compatibility of the said polymers with the surface-active agents present in the composition (washing, rinsing, drying or ironing composition) for the treatment of articles made of textile fibres.

Mention may be made, as examples, of the quaternary ammonium, nitrile, sulphonate, phosphonate or phosphate functional groups.

Mention may in particular be made of:
4-aminobenzenesulphonic acid and its ammonium or alkali metal salts, in particular its sodium salt [monomer of formula (II)]
5-sulphosalicylic acid [monomer of formula (II)]
D- or L-2-amino-5-phosphonovaleric acid [monomer of formula (II)]
sulphobenzoic acid and its ammonium or alkali metal salts [monomer of formula (III) or (IV)]
epoxypropyltrimethylammonium chloride [monomer of formula (III) or (IV)].

The dendritic polymers (P) employed according to the invention can be compared with arborescent structures having a focal point formed by the A functional group and a periphery covered with B endings.

Furthermore, when they are present, the bifunctional monomers (II) are spacing elements in the three-dimensional structure. They make it possible to control the branching density.

When they are present, the monomers (III) form nuclei. The “chain-limiting” monofunctional monomers (IV) are for their part situated at the periphery of the dendrimers.

The presence of monomers (III) and (IV) makes it possible to control the molecular weight.

Preferably, the dendritic polymers (P) employed according to the invention are hyperbranched polyamides; they are obtained from at least one monomer of formula (I) exhibiting, as reactive polycondensation functional groups, amino functional groups and carboxyl antagonistic functional groups or from a monomer composition comprising in addition at least one monomer of formula (II) and/or (III) and/or (IV) exhibiting the same type(s) of reactive polycondensation functional group(s), it being possible for all or part of the monomer or monomers of formula (II) to be replaced by a lactam.

The polycondensation/polymerization operation can be carried out in a known way in the molten or solvent phase, it being possible for the monomer of formula (II), when it is present, to favourably act as solvent.

The operation can favourably be carried out in the presence of at least one polycondensation catalyst and optionally of at least one antioxidant. Such catalysts and antioxidants are known to a person skilled in the art. Mention may be made, as examples of catalysts, of phosphorus compounds, such as phosphoric acid, phosphorous acid, hypophosphorous acid, phenylphosphonic acids, such as 2-(2′-pyridyl)ethylphosphonic acid, or phosphites, such as tris(2,4-di(tert-butyl)phenyl)phosphite. Mention may be made, as examples of antioxidants, of antioxidants with a doubly-hindered phenol base, such as N,N′-hexamethylenebis(3,5-di(tert-butyl)-4-hydroxyhydrocinnamamide) or 5-tert-butyl-4-hydroxy-2-methylphenyl sulphide.

Hyperbranched polyamides exhibiting hydrophilic functionalities which do not react with the A, A′, A″, B, B′ and B″ functional groups can be obtained by employing a monomer of formula (III) and/or (IV) exhibiting one or more polyoxyethylene groups (monomer of the family of the Jeffamine aminated polyoxyalkylenes) and/or a monomer of formula (IV) exhibiting quaternary ammonium, nitrile, sulphonate, phosphonate or phosphate functional groups. Another embodiment consists, after preparing a hyperbranched polyamide by polycondensation of nonfunctionalized monomers, in modifying the end functional groups of the said hyperbranched polyamide by reaction with a compound exhibiting quaternary ammonium nitrile, sulphonate, phosphonate or phosphate functional groups or polyoxyethylene groups.

The weight-average molar mass of the said dendritic polymers, in particular hyperbranched polyamides, can range from 1000 to 1 000 000 g/mol, preferably from 5000 to 500 000 g/mol.

The weight-average molar mass can be measured by size exclusion chromatography. The measurement is carried out in an eluent phase composed of 70% by volume of Millipore 18 megaohms water and of 30% by volume of methanol, comprising 0.1lM of NaNO₃; it is adjusted to pH 10 (1/1000 25% NH₄OH).

The weight-average molar mass is established in a known way via light scattering values.

The treatment composition according to the invention can comprise from 0.001 to 10%, preferably from 0.01 to 5%, of its weight of the dendritic polymer (P).

A second subject-matter of the invention is the use, in a composition for the treatment of articles made of textile fibres which is intended to be employed for washing and/or rinsing, drying in a tumble dryer or ironing articles made of textile fibres, of at least one dendritic polymer (P) as agent which makes it possible to contribute, to the said articles, antiwrinkling properties or ease-of-ironing properties.

A third subject-matter of the invention is a process for improving the properties of a composition which is intended for washing and/or rinsing, drying in a tumble dryer or ironing in an aqueous or wet medium articles made of textile fibres by addition to the said composition of at least one dendritic polymer (P) in an amount which is effective in contributing, to the said articles, antiwrinkling properties or ease-of-ironing properties.

The composition and the operating (or treatment) conditions can have many forms.

The said compositions can be provided

in the form of a solid (powder, granules, bars, and the like) or of a concentrated aqueous solution or dispersion intended to be brought into contact with the articles to be treated after dilution in water;

in the form of an aqueous solution or dispersion to be deposited directly on the dry articles to be treated without dilution;

in the form of an insoluble solid support comprising the said dendritic polymer brought into contact directly with the articles to be treated in the wet state.

Thus, the composition according to the invention can be:
a solid or liquid detergent formulation capable of directly forming a detergent bath by dilution;
a liquid rinsing formulation capable of directly forming the rinsing bath by dilution;
a solid material, in particular a textile material, comprising a said dendritic polymer, intended to be brought into contact with wet articles in a tumble dryer (the said solid material is referred to below as “drying additive”);
an aqueous ironing formulation.

The composition according to the invention is particularly well suited to the treatment of the laundry, in particular cotton-based laundry, in particular comprising at least 35% of cotton.

The operating pH of the composition according to the invention can range from approximately 2 to approximately 12, depending upon the use desired. When it is
a detergent formulation, the pH of the detergent bath is generally of the order of 7 to 11, preferably of 8 to 10.5;
a rinsing formulation, the pH of the rinsing bath is generally of the order of 2 to 8;
a drying additive, the pH to be considered is that of the residual water, which can be of the order of2 to 9;
an aqueous ironing formulation, the pH of the said formulation is generally of the order of 5 to 9.

The amount of dendritic polymer (P) present in the composition in order to contribute antiwrinkling properties or ease-of-ironing properties according to the invention can range from 0.001 to 10% on a dry basis of the weight of the said composition, this being according to the application desired.

Thus, the said dendritic polymer (P) can be employed as follows:

| % of (P) | In a composition used as |
|---|---|
| 0.001-5 | Detergent formulation |
| preferably 0.1-2 | |
| very particularly 0.1-1 | |
| 0.001-5 | Rinsing and/or softening formulation |
| preferably 0.01-2 | |
| very particularly 0.01-1 | |
| 0.001-10 | Drying additive |
| preferably 0.01-5 | |
| 0.001-5 | Ironing formulation |

In addition to the dendritic polymer (P), other constituents may be present in the composition according to the invention. The said composition can comprise at least one surface-active agent and/or one builder and/or one additive for rinsing articles made of textile fibres and/or one solid support (in particular textile support) of the said dendritic polymer (P).

The nature of these constituents depends on the use desired for the said composition.

Thus, when it is a detergent formulation for washing the laundry, this formulation generally comprises:
at least one natural and/or synthetic surface-active agent,
at least one builder,
optionally an oxidizing agent or system,
and a series of specific additives.

The detergent formulation can comprise surface-active agents in an amount corresponding to approximately 3 to 40% by weight with respect to the detergent formulation, surface-active agents such as

Anionic Surface-Active Agents

alkyl ester sulphonates of formula R—CH(SO₃M)-COOR′, where R represents a C₈₋₂₀, preferably C₁₀-C₁₆, alkyl radical, R′ a C₁-C₆, preferably C₁-C₃, alkyl radical and M an alkali metal cation (sodium, potassium or lithium), a substituted or unsubstituted ammonium (methyl-, dimethyl-, trimethyl- or tetramethylammonium, dimethylpiperidinium, and the like) cation or a cation derived from an alkanolamine (monoethanolamine, diethanolamine, triethanolamine, and the like). Mention may very particularly be made of the methyl ester sulphonates for which the R radical is a C₁₄-C₁₆ radical;
alkyl sulphates of formula ROSO₃M, where R represents a C₅-C₂₄, preferably C₁₀-C₁₈, alkyl or hydroxyalkyl radical, M representing a hydrogen atom or a cation with the same definition as above, and their ethoxylated (EO) and/or propoxylated (PO) derivatives exhibiting an average of 0.5 to 30, preferably of 0.5 to 10, EO and/or PO units;
alkylamide sulphates of formula RCONHR′OSO₃M, where R represents a C₂-C₂₂, preferably C₆-C₂₀, alkyl radical, R′ represents a C₂-C₃ alkyl radical, M representing a hydrogen atom or a cation with the same definition as above, and their ethoxylated (EO) and/or propoxylated (PO) derivatives exhibiting an average of 0.5 to 60 EO and/or PO units;
salts of saturated or unsaturated C₈-C₂₄, preferably C₁₄-C₂₀, fatty acids, C₉-C₂₀ alkylbenzenesulphonates, primary or secondary C₈-C₂₂ alkylsulphonates, alkylglycerol sulphonates, the sulphonated polycarboxylic acids disclosed in GB-A-1 082 179, paraffin sulphonates, N-acyl-N-alkyltaurates, alkyl phosphates, isethionates, alkylsuccinamates, alkylsulphosuccinates, the monoesters or diesters of sulphosuccinates, N-acylsarcosinates, alkylglycoside sulphates or polyethoxycarboxylates; the cation being an alkali metal (sodium, potassium, lithium), a substituted or unsubstituted ammonium residue (methyl-, dimethyl-, trimethyl- or tetramethylammonium, dimethylpiperidinium, and the like) or a residue derived from an alkanolamine (monoethanolamine, diethanolamine, triethanolamine, and the like);
   Nonionic Surface-Active Agents
polyoxyalkylenated (polyoxyethylenated, polyoxypropylenated or polyoxybutylenated) alkylphenols, the alkyl substituent of which is C₆-C₁₂, comprising from 5 to 25 oxyalkylene units; mention may be made, by way of example, of Triton X-45, Triton X-1 14, Triton X-100 or Triton X-102, sold by Röhm & Haas Co.;
glucosamides, glucamides or glycerolamides;
polyoxyalkylenated C₈-C₂₂ aliphatic alcohols comprising from 1 to 25 oxyalkylene (oxyethylene or oxypropylene) units; mention may be made, by way of example, of Tergitol 15-S-9 or Tergitol 24-L-6 NMW, sold by Union Carbide Corp., Neodol 45-9, Neodol 23-65, Neodol 45-7 or Neodol 45-4, sold by Shell Chemical Co., or Kyro EOB, sold by The Procter & Gamble Co.;
the products resulting from the condensation of ethylene oxide, the compound resulting from the condensation of propylene oxide with propylene glycol, such as the Pluronics sold by BASF;
the products resulting from the condensation of ethylene oxide, the compound resulting from the condensation of propylene oxide with ethylenediamine, such as the Tetronics sold by BASF;
amine oxides, such as (C₁₀-C₁₈ alkyl)dimethylamine oxides or (C₈-C₂₂ alkoxy)ethyldihydroxyethylamine oxides;
the alkylpolyglycosides disclosed in U.S. Pat. No. 4,565,647;
C₈-C₂₀ fatty acid amides;
ethoxylated fatty acids;
ethoxylated fatty amides;
ethoxylated amines;
   Amohoteric and Zwitterionic Surface-Active Agents
alkyl dimethyl betaines, alkyl amidopropyldimethyl betaines, alkyl trimethyl sulphobetaines, or the condensation products of fatty acids and of protein hydrolysates;
alkyl amphoacetates or alkyl amphodiacetates in which the alkyl group comprises from 6 to 20 carbon atoms.

Builders which improve the properties of surface-active agents can be employed in amounts corresponding to approximately 5-50%, preferably to approximately 5-30%, by weight for the liquid detergent formulations or to approximately 10-80%, preferably 15-50%, by weight for the powder detergent formulations, builders such as:

Inorganic Builders

alkali metal, ammonium or alkanolamine polyphosphates (tripolyphosphates, pyrophosphates, orthophosphates or hexametaphosphates);
tetraborates or borate precursors;
silicates, in particular those exhibiting an SiO₂/Na₂O ratio of the order of 1.6/1 to 3.2/1, and the lamellar silicates disclosed in U.S. Pat. No. 4,664,839;
alkali metal or alkaline earth metal carbonates (bicarbonates or sesquicarbonates);
cogranules of hydrated alkali metal silicates and of alkali metal carbonates (sodium carbonate or potassium carbonate) which are rich in silicon atoms in the Q2 or Q3 form, which are disclosed in EP-A-488 868;
crystalline or amorphous alkali metal (sodium or potassium) or ammonium aluminosilicates, such as zeolites A, P, X, and the like; zeolite A with a particle size of the order of 0.1-10 micrometres is preferred;
   Organic Builders
water-soluble polyphosphonates (ethane-1-hydroxy-1,1-diphosphonates, salts of methylenediphosphonates, and the like);
water-soluble salts of carboxyl polymers or copolymers or their water-soluble salts, such as:
polycarboxylate ethers (oxydisuccinic acid and its salts, tartrate monosuccinic acid and its salts, or tartrate disuccinic acid and its salts);
hydroxypolycarboxylate ethers;
citric acid and its salts, mellitic acid or succinic acid and their salts;
salts of polyacetic acids (ethylenediaminetetraacetates, nitrilotriacetates or N-(2-hydroxyethyl)nitrilodiacetates);
(C₅-C₂₀ alkyl)succinic acids and their salts (2-dodecenylsuccinates or laurylsuccinates);
polyacetal carboxylic esters;
polyaspartic acid, polyglutamic acid and their salts;
polyimides derived from the polycondensation of aspartic acid and/or of glutamic acid;
polycarboxymethylated derivatives of glutamic acid or of other amino acids.

The detergent formulation can additionally comprise at least one bleaching agent which releases oxygen comprising a percompound, preferably a persalt.

The said bleaching agent can be present in an amount corresponding to approximately 1 to 30%, preferably from 4 to 20%, by weight with respect to the detergent formulation.

Mention may in particular be made, as examples of percompounds capable of being used as bleaching agents, of perborates, such as sodium perborate monohydrate or tetrahydrate; or peroxygenated compounds, such as sodium carbonate peroxohydrate, pyrophosphate peroxohydrate, urea hydrogen peroxide, sodium peroxide or sodium persulphate.

The preferred bleaching agents are sodium perborate monohydrate or tetrahydrate and/or sodium carbonate peroxohydrate.

The said agents are generally used in combination with a bleaching activator which generates in situ, in the detergent medium, a peroxycarboxylic acid in an amount corresponding to approximately 0.1 to 12%, preferably from 0.5 to 8%, by weight with respect to the detergent formulation. Mention may be made, among these activators, of tetraacetylethylenediamine, tetraacetylmethylenediamine, tetraacetylglycoluril, sodium p-acetoxybenzenesulphonate, pentaacetylglucose or octaacetyllactose.

Mention may also be made of non-oxygenated bleaching agents, which act by photoactivation in the presence of oxygen, agents such as sulphonated zinc and/or aluminium phthalocyanines.

The detergent formulation can additionally comprise other soil release agents, antiredeposition agents, chelating agents, dispersing agents, fluorescence agents, foam-suppressant agents, softeners, enzymes and various other additives.

Soil Release Agents

They can be employed in amounts of approximately 0.01-10%, preferably approximately 0.1-5% and more preferably of the order of 0.2-3%, by weight.

Mention may more particularly be made of agents such as:
cellulose derivatives, such as cellulose hydroxy ethers, methylcellulose, ethylcellulose, hydroxypropyl methylcellulose or hydroxybutyl methylcellulose;
poly(vinyl ester)s grafted onto polyalkylene back-bones, such as poly(vinyl acetate)s grafted onto polyoxyethylene backbones (EP-A-219 048);
poly(vinyl alcohol)s;
polyester copolymers based on ethylene terephthalate and/or propylene terephthalate and polyoxyethylene terephthalate units, with an ethylene terephthalate and/or propylene terephthalate (number of units)/polyoxyethylene terephthalate (number of units) molar ratio of the order of 1/10 to 10/1, preferably of the order of 1/1 to 9/1, the polyoxyethylene terephthalates exhibiting polyoxyethylene units having a molecular weight of the order of 300 to 5000, preferably of the order of 600 to 5000 (U.S. Pat. No. 3,959,230, U.S. Pat. No. 3,893,929, U.S. Pat. No. 4,116,896, U.S. Pat. No. 4,702,857 and U.S. Pat. No. 4,770,666);
sulphonated polyester oligomers, obtained by sulphonation of an oligomer derived from ethoxylated allyl alcohol, from dimethyl terephthalate and from 1,2-propanediol, exhibiting from 1 to 4 sulphonate groups (U.S. Pat. No. 4,968,451);
polyester copolymers based on propylene terephthalate and polyoxyethylene terephthalate units which are terminated by ethyl or methyl units (U.S. Pat. No. 4,711,730) or polyester oligomers which are terminated by alkylpolyethoxy groups (U.S. Pat. No. 4,702,857) or anionic sulphopolyethoxy (U.S. Pat. No. 4,721,580) or sulphoaroyl (U.S. Pat. No. 4,877,896) groups;
sulphonated polyester copolymers derived from terephthalic, isophthalic and sulphoisophthalic acid, anhydride or diester and from a diol (FR-A-2 720 399).
   Antiredeposition Agents

They can be employed in amounts generally of approximately 0.01-10% by weight for a powder detergent formulation and of approximately 0.01-5% by weight for a liquid detergent formulation.

Mention may in particular be made of agents such as:
ethoxylated monoamines or polyamines, or polymers of ethoxylated amines (U.S. Pat. No. 4,597,898, EP-A-11 984);
carboxymethylcellulose;
sulphonated polyester oligomers obtained by condensation of isophthalic acid, of dimethyl sulphosuccinate and of diethylene glycol (FR-A-2 236 926);
polyvinylpyrrolidones.
   Chelating Agents

Iron- and magnesium-chelating agents can be present in amounts of the order of 0.1-10%, preferably of the order of 0.1-3%, by weight.

Mention may be made, inter alia, of:
aminocarboxylates, such as ethylenediaminetetraacetates, hydroxyethyl-ethylenediaminetriacetates or nitrilotriacetates;
aminophosphonates, such as nitrilotris(methylenephosphonates);
polyfunctional aromatic compounds, such as dihydroxydisulphobenzenes.
   Polymeric Dispersing Agents

They can be present in an amount of the order of 0.1-7% by weight, in order to control the calcium and magnesium hardness, agents such as
water-soluble salts of polycarboxylic acids with a molecular mass of the order of 2000 to 100 000, obtained by polymerization or copolymerization of ethylenically unsaturated carboxylic acids, such as acrylic acid, maleic acid or anhydride, fumaric acid, itaconic acid, aconitic acid, mesaconic acid, citraconic acid or methylenemalonic acid, and very particularly polyacrylates with a molecular mass of the order of 2000 to 10 000 (U.S. Pat. No. 3,308,067) or copolymers of acrylic acid and of maleic anhydride with a molecular mass of the order of 5000 to 75 000 (EP-A-66 915);
poly(ethylene glycol)s with a molecular mass of the order of 1000 to 50 000.
   Fluorescence Agents (Brighteners)

They can be present in an amount of approximately 0.05-1.2% by weight, agents such as: derivatives of stilbene, pyrazoline, coumarin, fumaric acid, cinnamic acid, azoles, methinecyanines, thiophenes, and the like (“The Production and Application of Fluorescent Brightening Agents”, M. Zahradnik, published by John Wiley & Sons, New York, 1982).

Foam-Suppressant Agents

They can be present in amounts which can range up to 5% by weight, agents such as:
C₁₀-C₂₄ fatty monocarboxylic acids or their alkali metal, ammonium or alkanolamine salts, or fatty acid triglycerides;
saturated or unsaturated, aliphatic, alicyclic, aromatic or heterocyclic hydrocarbons, such as paraffins or waxes;
N-alkylaminotriazines;
monostearyl phosphates or monostearyl alcohol phosphates;
polyorganosiloxane oils or resins, optionally combined with silica particles.
   Softeners

They can be present in amounts of approximately 0.5-10% by weight, softeners such as clays.

Enzymes

They can be present in an amount which can range up to 5 mg by weight, preferably of the order of 0.05-3 mg, of active enzyme/g of detergent formulation, enzymes such as:
proteases, amylases, lipases, cellulases or peroxydases (U.S. Pat. No. 3,553,139, U.S. Pat. No. 4,101,457, U.S. Pat. No. 4,507,219 and U.S. Pat. No. 4,261,868).
   Other Additives

Mention may be made, inter alia, of:
buffer agents,
fragrances,
pigments.

The detergent formulation can be employed, in particular in a washing machine, in a proportion of 0.5 g/l to 20 g/l, preferably of 2 g/l to 10 g/l, to carry out washing operations at a temperature of the order of 25 to 90° C.

A second embodiment of the invention is an aqueous liquid formulation for rinsing the laundry employed in particular in a washing machine. This formulation can be employed in a proportion of 0.2 to 10 g/l, preferably of 2 to 10 g/l.

In addition to the said dendritic polymer (P), other constituents of the following types can be present:
combinations of cationic surface-active agents (diester of triethanolamine quaternized by dimethyl sulphate, N-methylimidazoline tallow ester methyl sulphate, dialkyldimethylammonium chloride, alkylbenzyldimethylammonium chloride, alkylimidazolinium methyl sulphate, methylbis(alkylamidoethyl)-(2-hydroxyethyl)ammonium methyl sulphate and the like) in an amount which can range from 3 to 50%, preferably from 4 to 30%, of the said formulation, optionally in combination with nonionic surfactants (ethoxylated fatty alcohols, ethoxylated alkylphenol, and the like) in an amount which can range up to 3%;
polyorganosiloxanes (0.1 to 10%);
fluorescent whitening agents (0.1 to 0.2%);
optionally colour-fast agents (polyvinylpyrrolidone, polyvinyloxazolidone, polymethacrylamide, and the like) (0.03 to 25%, preferably 0.1 to 15%);
colorants;
fragrances;
solvents, in particular alcohols (methanol, ethanol, propanol, isopropanol, ethylene glycol or glycerol);
foam limiters.

A third embodiment of the invention is an additive for drying the laundry in an appropriate drying machine.

The said additive comprises a flexible solid support, for example composed of a strip of woven or nonwoven textile or a sheet of cellulose, impregnated with the said dendritic polymer (P); the said additive is introduced at the drying into the wet laundry to be dried at a temperature of the order of 50 to 80° C. for 10 to 60 minutes. The said additive can additionally comprise cationic softeners (up to 99%) and colour-fast agents (up to 80%), such as those mentioned above.

A fourth embodiment of the invention is an ironing formulation which can be sprayed directly over the dry laundry before the ironing operation. The said formulation can additionally comprise nonionic surface-active agents (from 0.5 to 5%), anionic surface-active agents (from 0.5 to 5%), fragrances (0.1 to 3%) or cellulose derivatives (0.1 to 3%), such as starch.

The following examples are given by way of illustration.

The weight-average molar mass is determined as follows by size exclusion chromatography.

The measurement is carried out in an eluent phase composed of 70% by volume of Millipore 18 megaohms water and of 30% by volume of methanol, comprising 0.1M of NaNO₃; it is adjusted to pH 10 (1/1000 25% NH₄OH).

The characteristics of the device are as follows:
Chromatographic columns: 1 Shodex SB806HQ column (30 cm, 5 μm) and one ASAHI GFA30 column (60 cm, 5 μm).
Injector-pump: Waters 515 for the pumping of the eluent and Wisp 717 from Waters for the injection.
The chromatographic system is equipped with the following detectors:

Waters 410 RI refractometer

TSP UV2000 dual wavelength=320 nm (1 OD)

Light scattering detector: MALLS, Wyatt (Laser He 633 nm)

Flow rate: 0.8 ml/minute.

The injection solution (200 μl) comprises approximately 0.2% by weight of hyperbranched polyamide.

The weight-average molecular mass is established directly without calibration using the light scattering values extrapolated to zero angle; these values are proportional to C×M×(dn/dc)²:
C corresponding to the concentration of hyperbranched polyamide
M corresponding to the weight-average molar mass
n corresponding to the optical index of the solution
the ratio dn/dc is established by the refractometric detector.

### EXAMPLE 1

Synthesis of a Hyperbranched Copolyamide Comprising Carboxylic Acid Endings by Copolycondensation in the Melt of 5-aminoisophthalic acid (Referred to as AIPA, Branching Molecule of A-R′—B₂ Type, with A=NH₂ and B═CO₂H) and of ε-caprolactam (Referred to as CL, Spacer of A-R″—B Type). The AIPA/CL Stoichiometric Ratio is 1/1.

The reaction is carried out at atmospheric pressure in a 500 ml glass reactor commonly used in the laboratory for the synthesis in the melt of polyesters or of polyamides.

The monomers are fully charged at the beginning of the test to the reactor preheated to 120° C. 50.72 g of 5-aminoisophthalic acid (0.28 mol), 31.6 g of ε-caprolactam (0.28 mol) and 30 μl of a 50% (w/w) aqueous hypophosphorous acid solution are successively introduced into the reactor. The reactor is purged by a sequence of placing under vacuum and of re-establishing atmospheric pressure using dry nitrogen.

Stirring is begun at 40 rev/min. The reaction mass is gradually heated from 120° C. to 260° C. over 70 min. The temperature is then maintained at a plateau of 260° C. After 10 minutes, the reactor is placed under vacuum until distillation is finished. 73.44 g of polymer and 6.69 g of distillate are collected.

The hyperbranched polyamide comprising carboxylic acid endings obtained is vitreous and translucent.

The Mn and Mw values obtained by steric exclusion chromatography equipped with light scattering detection are respectively 140 000 and 150 000 g/mol.

### EXAMPLE 2

Synthesis of a Hyperbranched Copolyamide Comprising Ammonium Carboxylate Endings by Neutralization by Ammonia of the Hyperbranched Copolyamide Comprising Carboxylic Acid Endings Obtained in Example 1

67 g of the hyperbranched polyamide obtained in Example 1 (242 mmol of COOH) are dispersed in 200 ml of water in a 500 ml Erlenmeyer flask. 20.6 g of 20% by weight aqueous ammonia solution (242 mmol) are subsequently added dropwise. The mixture is stirred mechanically and is maintained under these conditions until dissolution is complete. The unreacted ammonia is subsequently evaporated on a rotary evaporator. The hyperbranched polyamide comprising ammonium carboxylate endings is subsequently isolated by lyophilization.

### EXAMPLE 3

Synthesis of a Hyperbranched Copolyamide Comprising Carboxylic Acid Endings by Copolycondensation in the Melt of 1,3,5-benzenetricarboxylic acid (Referred to as BTC, Core Molecule of R—B₃ Type, with B═COOH), of 5-aminoisophthalic acid (Referred to as AIPA, Branching Molecule of A-R′—B₂ Type, with A=NH₂) and of ε-caprolactam (Referred to as CL, Spacer of A-R″—B Type). The Respective Overall Composition is 1/25/25 in BTC/AIPA/CL

The reaction is carried out at atmospheric pressure in a 7.5 l autoclave commonly used for the synthesis in the melt of polyesters or of polyamides.

The monomers are fully charged at the beginning of the test to the reactor at ambient temperature. 1131.5 g of ε-caprolactam (10.0 mol), 1811.5 g of 5-aminoisophthalic acid (10.0 mol), 84.0 g of 1,3,5-benzenetricarboxylic acid (0.4 mol) and 1.35 g of a 50% (w/w) aqueous hypophosphorous acid solution are successively introduced into the reactor. The reactor is purged by a series of 4 sequences of placing under vacuum and of re-establishing atmospheric pressure using dry nitrogen.

Stirring is then adjusted to 50 rev/min. The reaction mass is gradually heated from ambient temperature (20° C.) to 240° C. over 160 min. The temperature is then maintained at a plateau of 240° C. for an additional 15 to 30 minutes approximately. At the end of the cycle, stirring is halted and the reactor is placed under an excess nitrogen pressure. Subsequently, the bottom valve is gradually opened and the polymer is run out at 240° C. into a stainless steel bucket.

### EXAMPLE 4

Synthesis of a Hyperbranched Copolyamide Comprising Sodium Carboxylate Endings by Neutralization with Sodium Hydroxide of the Hyperbranched Copolyamide Comprising Carboxylic Acid Endings Synthesized in Example 3

7 litres of 1N sodium hydroxide solution and then 1792.6 g of hyperbranched polyamide of Example 3 are introduced into the 7.5 litre autoclave. The mixture is stirred mechanically and is gently heated under nitrogen to facilitate the dissolution of the hyperbranched polyamide. The solution is subsequently filtered and then precipitated by introducing onto 28 litres of ethanol with stirring using an UltraTurrax.

The polymer is isolated by filtration and then dried in an oven.

The elemental analysis makes it possible to obtain the sodium content and thus the functionality of the hyperbranched copolyamide; the analysis gives a sodium content of 7.0% by weight.

The Mn and Mw values obtained by steric exclusion chromatography equipped with light scattering detection are respectively 5900. and 12 200 g/mol.

### EXAMPLE 5

Preparation of a Hyperbranched Copolyamide Comprising Quaternary Ammonium and Sodium Carboxylate Endings by Grafting QUAB 151® to the Hyperbranched Copolyamide Comprising Sodium Carboxylate Endings Obtained in Example 4

40.0 g of hyperbranched copolyamide exhibiting a sodium content of 7.0% (122.0 mmol of COONa) obtained in Example 4, 40 ml of water and 6.57 g of 70% epoxypropyltrimethylammonium chloride (QUAB 151®) (30.5 mmol) are charged to a round-bottomed glass flask. The targeted degree of conversion of COONa to quaternary ammonium is thus 25%.

The reaction mixture is subsequently heated to 70° C. over 40 minutes and is then maintained at this temperature for 27 hours. The solution is subsequently transferred into a separating funnel, the round-bottomed flask being rinsed using 4 times 35 ml of water. The unreacted QUAB 151® is extracted with 2 times 150 ml of ethyl ether.

The aqueous phase is subsequently evaporated on a rotary evaporator and the hyperbranched copolyamide comprising mixed sodium carboxylate and quaternary ammonium endings is thus recovered.

### EXAMPLE 6

Antiwrinkling Evaluation Test

Washing Formulation

The washing formulation employed when carrying out the antiwrinkling evaluation test is as follows:

Washing formulation (L)

| Constituents | % by weight |
|---|---|
| NaTPP | 30 |
| Silicate 2 SiO₂, Na₂O | 5 |
| Sodium carbonate | 5 |
| Acrylate/maleate copolymer | 6 |
| Sokalan CP5 (BASF) | |
| Sodium sulphate | 8 |
| CMC, Blanose 7MXF (Hercules) | 1 |
| Perborate monohydrate | 15 |
| Granulated TAED | 5 |
| Anionic surfactant | 10 |
| Laurylbenzenesulphonate (Nansa) | |
| Nonionic surfactant | 5 |
| Synperonic A3 (ethoxylated alcohol, | |
| 3 EO, ICI) | |
| Nonionic surfactant | 8 |
| Synperonic A9 (ethoxylated alcohol, | |
| 9 EO, ICI) | |
| Fragrances | 1 |
| Test polymer | 1 |

Evaluation Method
1. Preparation of the fabrics
2. Treatment of the fabrics: in a Tergotometer by washing using the washing formulation (L) comprising the test polymer, followed by rinsing with water
3. Wrinkling the fabric
4. Evaluation of the wrinkling by an optical method

1. Test specimens with dimensions of 10×10 cm are cut out from unfinished cotton (supplied under the reference 2436W by Phoenix Colio Ltd).

The cotton test specimens are first ironed so that they all have the same level of wrinkling before washing.

2. A washing operation is carried out in a Tergototometer laboratory device well known in the profession to detergent composition formulators. The device simulates the mechanical and thermal effects of pulsating-type American washing machines. The test specimens are washed using the above washing formulations and are rinsed 3 times with water, under the following conditions:
number of test specimens per drum of the Tergotometer: 10
volume of water: 1 litre
water of French hardness 30° TH obtained by appropriate dilution of mineral water with the Contrexéville® trade mark
concentration of washing formulation (L): 5 g/l
washing temperature: 40° C.
washing time: 20 min
stirring speed of the Tergotometer: 100 revolutions/minute
3 rinsing operations with cold water (approximately 30° TH)
duration of each rinsing operation: 5 minutes

3. The wet test specimens are subsequently wrinkled using a cylinder press (diameter of 5.5 cm×length of 7 cm); the pressure exerted is 20 g/cm² for 90 seconds.

They are subsequently dried horizontally overnight.

This wrinkling method makes it possible to obtain reproducible wrinkling over all the tests.

4. After drying for 24 hours, a digital colour photograph is taken of an area of the dry test specimens and is subsequently converted to 256 levels of grey (grey scale from 0 to 255).

The number of pixels corresponding to each level of grey is counted.

For each histogram obtained, the standard deviation σ of the distribution of the level of grey is measured.

If wrinkling is high, the distribution of the level of grey is broad.

σ1 corresponds to the standard deviation obtained with a washing formulation (L′) similar to (L) but devoid of test polymer.

σ2 corresponds to the standard deviation obtained with the washing formulation (L) including the test polymer.

σ3 corresponds to the standard deviation obtained on ironed starting test specimens (stage 1 of preparation of the fabrics) which have not been subjected to stages 2 and 3 of treatment of and ironing the fabrics.

The WR (Wrinkle Recovery) performance value is given by the following equation:
WR (%)=[(σ1−σ2)/σ1]f×100

f being a normalization factor equal to 1/[(σ1−σ3)/σ1].

A value of:
0% corresponds to zero benefit
100% corresponds to an unwrinkled surface (flat surface obtained after ironing)

The results of the wrinkling test are as follows:

| Hyperbranched copolyamide of | WR |
|---|---|
| Example | in % |
| 2 | 34% |
| 4 | 29% |
| 5 | 19% |

### EXAMPLE 7

Rinsing Formulation:

| Rinsing formulation (R) | |
|---|---|
| Constituents | % by weight |
| Cationic surfactant: Ditallowdimethyl- | 15% |
| ammonium chloride | |
| Fragrance | 1% |
| HCl to obtain a pH = 3 | 0.2% |
| Hyperbranched copolyamide | 0.1 to 5% |
| Water | 93.7 to 78.8% |

1-17. (canceled)

18) A composition for the treatment of articles made of textile fibres which is intended to be used for washing and/or rinsing, drying in a tumble dryer or ironing articles made of textile fibres comprising at least one water-soluble or water-dispersible dendritic or hyperbranched polymer (P) made by the process comprising the steps of:
a) performing a polycondensation of at least one multifunctional monomer of formula (I) comprising at least three reactive polycondensation functional groups,
A-R—(B)_{f} (I)
in which formula
f is an integer greater than or equal to 2,
the symbol A represents a reactive functional group or a group carrying a reactive functional group chosen from the amino, carboxyl, hydroxyl, oxiranyl, halo or isocyanato functional groups or their precursors,
the symbol B represents a reactive functional group or a group carrying a reactive functional group chosen from the amino, carboxyl, hydroxyl, oxiranyl, halo or isocyanato functional groups or their precursors which is an antagonist of A,
the symbol R represents a linear or branched aliphatic, cycloaliphatic or aromatic polyvalent hydrocarbon residue comprising from 1 to 50 carbon atoms which is optionally interrupted by one or more oxygen, nitrogen, sulphur or phosphorus heteroatoms, said residue optionally carrying functional groups not capable of reacting with the A and B functional groups, and, optionally,
b) performing a at least partial hydrophilic functionalization of the polymer obtained in the polycondensation stage a).

19) The composition according to claim 18, wherein in step a), f is ranging from 2 to 10, the symbol R represents a linear or branched aliphatic, cycloaliphatic or aromatic polyvalent hydrocarbon residue comprising from 3 to 20, carbon atoms which is optionally interrupted by one or more oxygen, nitrogen, sulphur or phosphorus heteroatoms, said residue optionally carrying functional groups not capable of reacting with the A and B functional groups.

20) The composition according to claim 18, wherein said polycondensation operation is carried out in addition in the presence of at least one bifunctional monomer in the linear form of formula (II) in the corresponding cyclic form comprising two reactive polycondensation/polymerization functional groups
A′-R′—B′ (II)
in which formula
the symbol A′, which is identical to or different from A, represents a reactive functional group chosen from the amino, carboxyl, hydroxyl, oxiranyl, halo or isocyanato functional groups or their precursors which is an antagonist of B and B′,
the symbol B′, which is identical to or different from B, represents a reactive functional group chosen from the amino, carboxyl, hydroxyl, oxiranyl, halo or isocyanato functional groups or their precursors which is an antagonist of A and A′,
the symbol R′, which is identical to or different from R, represents a linear or branched aliphatic, cycloaliphatic or aromatic polyvalent hydrocarbon residue comprising from 1 to 50 carbon atoms which is optionally interrupted by one or more oxygen, nitrogen, sulphur or phosphorus heteroatoms, said residue optionally carrying functional groups not capable of reacting with the A, A′, B and B′ functional groups,
the reactive functional group A′ being capable of reacting with the B functional group and/or the B′ functional group by condensation;
the reactive functional group B′ being capable of reacting with the A functional group and/or the A′ functional group by condensation;
and/or of at least one “core” monomer of formula (III) comprising at least one functional group capable of reacting by condensation with the monomer of formula (I) and/or the monomer of formula (II)
R¹—(B″)ₙ (III)
in which formula
n is an integer greater than or equal to 1,
the symbol B″ represents a reactive functional group, identical to or different from B or B′, chosen from the amino, carboxyl, hydroxyl, oxiranyl, halo or isocyanato functional groups or their precursors which is an antagonist of A and A′,
the symbol R¹ represents a linear or branched aliphatic, cycloaliphatic or aromatic polyvalent hydrocarbon residue comprising from 1 to 50, carbon atoms which is optionally interrupted by one or more oxygen, nitrogen, sulphur or phosphorus heteroatoms or an organosiloxane or polyorganosiloxane residue, said R′ residue optionally carrying functional groups not capable of reacting with the A, A′, B, B′ and B″ functional groups,
the reactive functional group B″ being capable of reacting with the A functional group and/or the A′ functional group by condensation;
and/or of at least one “chain-limiting” monofunctional monomer of formula (IV)
A″-R² (IV)
in which formula
the symbol A″ represents a reactive functional group, identical to or different from A or A′, chosen from the amino, carboxyl, hydroxyl, oxiranyl, halo or isocyanato functional groups or their precursors which is an antagonist of B, B′ and B″,
the symbol R² represents a linear or branched aliphatic, cycloaliphatic or aromatic polyvalent hydrocarbon residue comprising from 1 to 50, carbon atoms which is optionally interrupted by one or more oxygen, nitrogen, sulphur or phosphorus heteroatoms or an organosiloxane or polyorganosiloxane residue, said R² residue optionally carrying functional groups not capable of reacting with the A, A′, A″, B, B′ and B″ functional groups,
the reactive functional group A″ being capable of reacting with the B functional group and/or the B′ functional group and/or the B″ functional group by condensation;
at least one of the reactive functional groups of at least one of the monomers of formula (II), (III) or (IV) being capable of reacting with an antagonistic functional group of the multifunctional monomer of formula (I).

21) The composition according to claim 20, wherein n is ranging from 1 to 100.

22) The composition according to claim 20, wherein:
the molar ratio of the monomer of formula (I) to the monomer of formula (II) is greater than 0.05;
the molar ratio of the monomer of formula (III) to the monomer of formula (I) is less than or equal to 1;
the molar ratio of the monomer of formula (IV) to the monomer of formula (I) is less than or equal to 10.

23) The composition according to claim 22, wherein the molar ratio of the monomer of formula (I) to the monomer of formula (II) ranges from 0.125 to 2;
the molar ratio of the monomer of formula (III) to the monomer of formula (I) ranges from 0 to 1/3;
the molar ratio of the monomer of formula (IV) to the monomer of formula (I) is less than or equal to 5.

24) The composition according to claim 18, wherein the functional groups optionally present in the monomers (I) to (IV) and which are not capable of reacting with the A, A′, A″, B, B′ and B″ functional groups are quaternary ammonium, nitrile, sulphonate, phosphonate or phosphate functional groups.

25) The composition according to claim 18, wherein the A, A′, A″ and B, B′, B″ functional groups are reactive functional groups or groups carrying reactive functional groups being amino, carboxyl, hydroxyl, oxiranyl functional groups or their precursors.

26) The composition according to claim 25, wherein said functional groups are reactive amino group, carboxyl functional groups, groups carrying reactive amino groups, groups carrying carboxyl functional groups or their precursors.

27) The composition according to claim 26, wherein the dendritic polymer (P) employed is a hyperbranched polyamide obtained from at least one monomer of formula (I) exhibiting, as reactive polycondensation functional groups, amino functional groups and carboxyl antagonistic functional groups or from a monomer composition comprising in addition at least one monomer of formula (II) and/or (III) and/or (IV) exhibiting the same type(s) of reactive polycondensation functional group(s), it being possible for all or part of the monomer or monomers of formula (II) to be replaced by a lactam.

28) The composition according to claim 27, wherein the hyperbranched polyamide exhibits hydrophilic functionalities which do not react with the A, A′, A″, B, B′ and B″ functional groups and is obtained by employing a monomer of formula (III) and/or (IV) exhibiting one or more polyoxyethylene groups and/or a monomer of formula (IV) exhibiting quaternary ammonium, nitrile, sulphonate, phosphonate or phosphate functional groups.

29) The composition according to claim 28, wherein the hyperbranched polyamide exhibits hydrophilic functionalities which do not react with the A, A′, A″, B, B′ and B″ functional groups and obtained by polycondensation of nonfunctionalized monomers and then by modification of the end functional groups of said hyperbranched polyamide by reaction with a compound exhibiting quaternary ammonium, nitrile, sulphonate, phosphonate, phosphate, or polyoxyethylene groups.

30) The composition according to claim 18, wherein the dendritic polymers, have a weight-average molar mass from 1000 to 1 000 000 g/mol.

31) The composition according to claim 18, having from 0.001 to 10%, of its weight of the dendritic polymer (P).

32) A process for the treatment of articles made of textile fibres comprising the step of treating said articles during a process of washing and/or rinsing, drying in a tumble dryer or ironing said articles in an aqueous or wet medium, with a composition as defined in claim 18, as agent contributing, to said articles, antiwrinkling properties or ease-of-ironing properties, said composition having a proportion of dendritic polymer (P) of 0.001 to 10%, by weight of said composition.

33) The process according to claim 32, wherein the proportion is of 0.01 to 5%.

34) The composition according to claim 18, provided in the form of:
a solid or of a concentrated aqueous solution or dispersion intended to be brought into contact with articles to be treated after dilution in water;
an aqueous solution or dispersion to be deposited directly on dry articles to be treated without dilution; or
an insoluble solid support comprising said dendritic polymer brought into contact directly with articles to be treated in a wet state.

35) The composition, according to claim 34, wherein said composition is:
a solid or liquid detergent formulation comprising from 0.001 to 5% by weight of the dendritic polymer (P) capable of directly forming a detergent bath by dilution;
a liquid rinsing formulation comprising from 0.001 to 5% by weight of dendritic polymer (P) capable of directly forming a rinsing bath by dilution;
a solid material, in particular a textile material, comprising from 0.001 to 10% by weight of dendritic polymer (P) intended to be brought into contact with wet articles in a tumble dryer; or
an aqueous ironing formulation comprising from 0.001 to 5% by weight of dendritic polymer (P).

36) The composition, according to claim 35, wherein said composition is:
a solid or liquid detergent formulation comprising from 0.1 to 2%, by weight of the dendritic polymer (P) capable of directly forming a detergent bath by dilution;
a liquid rinsing formulation comprising from 0.01 to 2%, by weight of dendritic polymer (P) capable of directly forming a rinsing bath by dilution; or
a solid material, in particular a textile material, comprising from 0.01 to 5%, by weight of dendritic polymer (P) intended to be brought into contact with wet articles in a tumble dryer.
